(19) United States
(12) Patent Application Publication
(10) Pub. No.: US 2003/0068555 A1
(43) Pub. Date: Apr. 10, 2003

(54) Non-aqueous electrolyte secondary battery

(76) Inventor: Yoshinori Naruoka, Kyoto-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/125,511

(22) Filed: Apr. 19, 2002

(30) Foreign Application Priority Data
Apr. 20, 2001 (JP) 2001-122758
Apr. 26, 2001 (JP) 2001-128939

(51) Int. Cl. H01M 4/58; H01M 4/62; H01M 4/50

(52) U.S. Cl. 429/231.4; 429/232; 429/224; 429/231.1

(57) ABSTRACT

To provide a non-aqueous electrolyte secondary battery including a positive electrode containing a positive active material capable of intercalating and deintercalating lithium ion and a negative electrode containing a first carbon material capable of intercalating and deintercalating lithium ion and a second carbon material having a specific surface area of about 10 to about 1500 m²/g. According to the present invention, increase in a charge transfer resistance of the negative electrode is suppressed by the second carbon material having a specific surface area of about 10 to about 1500 m²/g, and therefore, a discharge capacity, cycle life performance, discharge rate characteristics and power characteristics of the battery can be improved. Furthermore, if a positive active material contains lithium manganese compound, the increase in the charge transfer resistance of the first carbon material due to eluted manganese is suppressed, and an area of the first carbon material intercalating and deintercalating lithium ion is prevented from being covered. Thus, the cycle life performance, discharge rate characteristics and power characteristics of the battery can be improved.

### BACKGROUND OF THE INVENTION

1. Field of the Invention

The present invention relates to a non-aqueous electrolyte secondary battery.

2. Description of the Prior Art

Recently, portable electronic devices have been remarkably reduced in size and weight, and accordingly, a demand for downsizing and weight reduction of a battery serving as a power supply therefor has been increased. To satisfy such a demand, various secondary batteries have been developed, and now, a non-aqueous electrolyte secondary battery, such as a lithium secondary battery, with a high operating voltage and a high energy density, is used. In the non-aqueous electrolyte secondary battery, a positive electrode is made of lithium cobalt oxide, which is a composite oxide having a layer structure, and a negative electrode is made of a carbon material capable of intercalating and deintercalating lithium ion, for example.

However, the non-aqueous electrolyte secondary battery has a disadvantage in that a charge transfer resistance thereof increases and a discharge capacity thereof gradually decreases in the course of charge and discharge cycles. Specifically, the negative electrode expands and shrinks due to the intercalating and deintercalating of the lithium ion during the charge and discharge, thereby causing a crack in the carbon material. And, a surface film of the negative electrode grows during the charge and discharge. The occurrence of the crack and the growth of the surface film cause an increase in the charge transfer resistance. Thus, the discharge capacity of the non-aqueous electrolyte secondary battery gradually decreases in the course of the charge and discharge.

Thus, an object of the present invention is to control the increase in the charge transfer resistance to provide a non-aqueous electrolyte secondary battery with improved cycle life performance, discharge rate characteristics and power characteristics.

### SUMMARY OF THE INVENTION

The present invention provides a non-aqueous electrolyte secondary battery comprising a positive electrode containing a positive active material capable of intercalating and deintercalating lithium ion, and a negative electrode containing a first carbon material capable of intercalating and deintercalating lithium ion and a second carbon material having a specific surface area of about 10 to about 1500 m²/g.

According to this invention, the second carbon material having the specific surface area of about 10 to about 1500 m²/g suppresses the charge transfer resistance of the negative electrode, and therefore, the discharge capacity, cycle life performance, discharge rate characteristics and power characteristics of the battery can be improved.

The term “specific surface area” herein means the specific surface area according to the BET method.

The second carbon material is preferably carbon black. This is because a current collecting performance of the negative electrode is enhanced.

A second carbon material content in the sum of the first and second carbon materials is preferably less than about 10% by weight, more preferably equal to or more than about 0.1% by weight and equal to or less than about 5% by weight, and most preferably equal to or more than about 0.1% by weight and equal to or less than about 1% by weight.

This is because the second carbon material content less than about 10% by weight provides a sufficiently low charge transfer resistance. On the other hand, when the second carbon material content is about 10% by weight or more, the first carbon material content is decreased accordingly, and therefore, the discharge capacity of the negative electrode may be reduced.

Furthermore, if the positive active material contains a lithium manganese compound, an advantage described below is provided. Generally, in the non-aqueous electrolyte secondary battery comprising the positive electrode containing the lithium manganese compound, if the lithium manganese compound is exposed to an electrolyte for a long time, manganese (Mn) is dissolved into the electrolyte from the lithium manganese compound. When the manganese, having been dissolved in the electrolyte, reaches the negative electrode, it may be deposited on the first carbon material, which is a negative active material, to cause the increase in the charge transfer resistance thereof. In addition, the area of the first carbon material intercalating and deintercalating lithium ion may be covered with the dissolved manganese, and therefore, the charge and discharge performance of the non-aqueous electrolyte secondary battery may be reduced. According to this invention, the negative electrode contains the second carbon material, and the manganese is captured on the negative electrode by the action of the second carbon material, so that the deposition of the manganese onto the first carbon material can be suppressed. Thus, the increase in the charge transfer resistance of the first carbon material can be suppressed, and the first carbon material intercalating and deintercalating lithium ion can be prevented from being covered. Therefore, the cycle life performance, the discharge rate characteristics and the power characteristics can be improved.

Besides, if the lithium manganese compound has a composition of LiₓMn_{2-y}M_{y}O₄ (0≦x≦1.4; 0≦y≦1.8; and M being one or more transition metal elements) or LiₓMn_{1-y}M_{y}O₂ (0≦x≦1.4; 0≦y≦0.9; and M being one or more transition metal elements), the non-aqueous electrolyte secondary battery with improved cycle life performance, discharge rate characteristics and power characteristics can be provided.

### BRIEF DESCRIPTION OF THE DRAWINGS

FIG. 1 is a perspective view of a non-aqueous electrolyte secondary battery according to an embodiment of this invention;

FIG. 2 is a perspective view of a generating element of the non-aqueous electrolyte secondary battery;

FIG. 3 is a graph showing a relationship between an acetylene black content and an initial discharge capacity;

FIG. 4 is a graph showing a relationship between a discharge current and a discharge capacity;

FIG. 5 is a graph showing a relationship between a specific surface area of acetylene black and an initial discharge capacity;

FIG. 6 is a graph showing a relationship between the specific surface area of the acetylene black and a discharge capacity retention;

FIG. 7 is a graph showing a relationship between a discharge current and a discharge capacity;

FIG. 8 is a graph showing a relationship between a DOD and a power density;

FIG. 9 is a graph showing a relationship between a discharge current and a discharge capacity; and

FIG. 10 is a graph showing a relationship between a DOD and a power density.

### DETAILED DESCRIPTION OF THE PREFERRED EMBODIMENTS

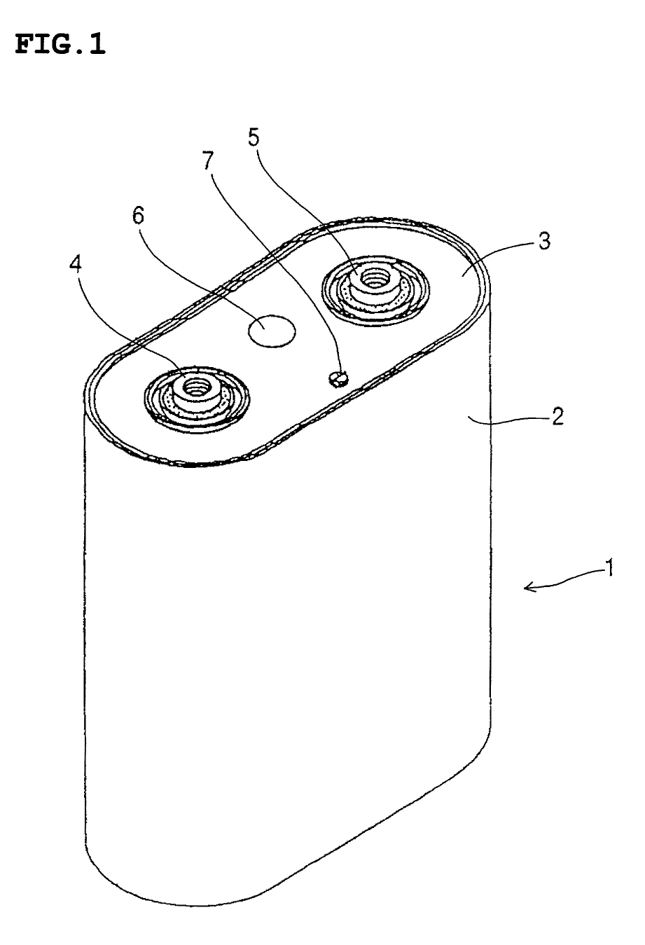

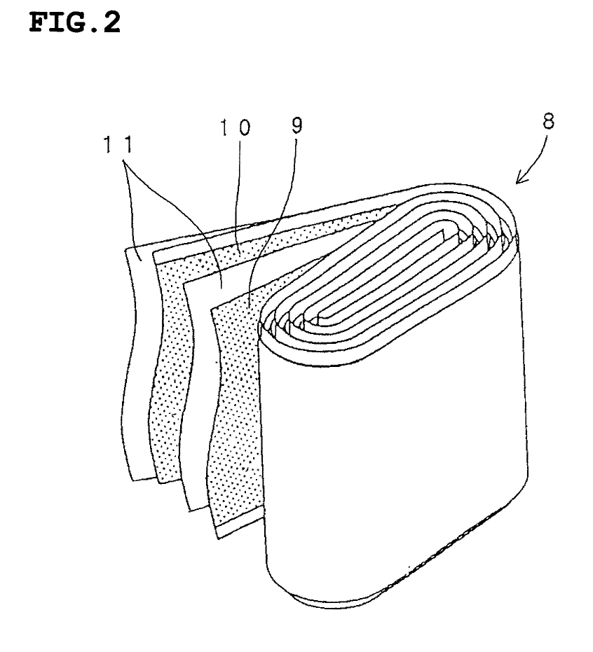

Now, one embodiment of the present invention will be described with reference to the drawings. As shown in FIGS. 1 and 2, a non-aqueous electrolyte secondary battery 1 of this invention is manufactured by winding together a positive electrode 9, a negative electrode 10 and separators 11 sandwiched therebetween into an elliptic cylinder to form a generating element 8, placing the generating element into a battery case 2, welding the battery case 2 and a battery lid 3 together, and then injecting a non-aqueous electrolyte into the battery case through an electrolyte injection hole 7. The lid 3 is provided with a safety valve 6, a positive electrode terminal 4 and a negative electrode terminal 5.

The negative electrode 10 comprises a current collector of negative electrode made of copper, nickel or stainless steel, for example, and negative active material layers of a negative compositive provided on both sides of the current collector.

As an example, the negative electrode 10 is manufactured as follows: the negative active material is mixed with a binder, such as polyvinylidene fluoride, to provide the negative compositive; the negative compositive is dispersed into a solvent, such as N-methylpyrrolidone, to provide a slurry; and the slurry is spread on both sides of the current collector of negative electrode and dried, and then the product is compressed and leveled by roller pressing or the like.

The negative electrode 10 includes a first carbon material capable of intercalating and releasing lithium ion and a second carbon material having a specific surface area of about 10 to about 1500 m²/g.

As the first carbon material, although not limited thereto, non-graphitizing carbon, graphitizing carbon, natural graphite, or artificial graphite may be used by itself, or a mixture of two or more thereof may be used.

The first carbon material, although not limited thereto, is preferably a carbon material having a specific surface area of about 0.1 to about 10 m²/g, more preferably of about 0.5 to about 8 m²/g, and most preferably of about 1 to about 5 m²/g. If the specific surface are a of the first carbon material is less than about 0.1 m²/g, an area where the first carbon material comes into contact with the second carbon material described later is reduced, and therefore, a sufficient performance may not be attained. On the other hand, if the specific surface area of the first carbon material is more than about 10 m²/g, a problem described below may arise. A negative electrode is manufactured by mixing a first carbon material, a second carbon material, a binder, an organic solvent and so on to prepare a paste, applying the paste onto a metallic foil, drying the paste, and then pressing the product. If the specific surface area of the first carbon material is more than about 10 m²/g, the pressing possibly cannot provide a sufficient adhesion between the first and second carbon materials or sufficient uniform adhesion between the metallic foil and the carbon material. Therefore, current collection may be degraded and the charge and discharge performance may be degraded.

Here, the term “specific surface area” of the first carbon material and the second carbon material described later means the specific surface area according to the BET method. For example, by means of the GEMINI 2370, Micromeritecs, manufactured by Shimadzu Corporation, the specific surface area can be determined through measurement according to the low temperature gas absorption using liquid nitrogen and analysis according to the BET method.

The second carbon material used in the non-aqueous electrolyte secondary battery 1 of this invention is a carbon material having a specific surface area of about 10 to about 1500 m²/g, preferably of about 20 to about 150 m²/g, and more preferably of about 40 to about 80 m²/g.

One reason for this is that, if the specific surface area of the second carbon material is less than about 10 m²/g, a conductivity of the second carbon material is low, and therefore, it is difficult to suppress the increase in the charge transfer resistance of the negative electrode containing the same.

Another reason for this is that, if the specific surface area of the second carbon material is equal to or more than about 10 m²/g, the manganese (Mn), which is dissolved into the electrolyte if the lithium manganese compound is used for the positive active material, is selectively captured on the second carbon material rather than the first carbon material, and therefore, the deposition of the manganese onto the first carbon material is effectively suppressed.

Besides, if the specific surface area of the second carbon material is more than about 1500 m²/g, the second carbon material intercalates the most of the organic solvent during the preparation of the paste by mixing the first carbon material, the second carbon material, the binder, the organic solvent and soon. Therefore, the preparation of the paste may become difficult.

In addition, from the viewpoint of suppressing a reaction between the negative electrode and the electrolyte to prevent an excessive formation of the surface film, a carbon material having a specific surface area of about 40 to about 80 m²/g is preferred.

Although not limited thereto, the second carbon material is carbon black including acetylene black, ketjen black, and furnace black. Among the carbon blacks, the acetylene black is particularly preferred. The acetylene black has a chain structure of aggregated particles and has the highest conductivity in the carbon blacks. Thus, the increase in the charge transfer resistance of the negative electrode containing the acetylene black is significantly suppressed, and the cycle life performance, the discharge rate characteristics and the power characteristics of the non-aqueous electrolyte secondary battery are remarkably improved. Here, the second carbon material may be used by itself, or a mixture of two or more of those described above may be used.

A second carbon material content in the sum of the first and second carbon materials is preferably less than about 10% by weight, more preferably equal to or more than about 0.1% by weight and equal to or less than about 5% by weight, and most preferably equal to or more than about 0.1% by weight and equal to or less than about 1% by weight.

This is because the second carbon material content less than about 10% by weight provides a sufficiently low charge transfer resistance. On the other hand, when the second carbon material content is about 10% by weight or more, the first carbon material content is decreased accordingly, and therefore, the discharge capacity of the negative electrode may be reduced.

The second carbon material itself also can intercalate and deintercalate lithium ion. The second carbon material is considered to contribute to the improvement of the discharge capacity, the cycle life performance, the discharge rate characteristics and the power characteristics of the battery also through the intercalating and deintercalating of lithium ion.

The positive electrode 9 comprises a current collector of positive electrode made of aluminum, nickel or stainless steel, for example, and positive active material layers containing a positive active material for intercalating and deintercalating lithium ion provided on both sides of the current collector.

As the positive active material, any compound may be used without restriction so far as it can intercalate and deintercalate lithium ion. The positive active material includes lithium-containing composite oxides represented by the composition of LiₓMO₂ (M being a transition metal element, and 0≦x≦1, 0≦y≦2) or Li_{y}M₂O₄ (M being a transition metal element, 0≦x≦1, 0≦y≦2), specifically, LiCoO₂, LiMnO₂, LiNiO₂ and LiMn₂O₄. As the positive active material, a single compound maybe used, or a mixture of two or more compounds may be used.

The present invention significantly improves the cycle life performance, the discharge rate characteristics and the power characteristics of the non-aqueous electrolyte secondary battery having a positive active material containing a lithium manganese compound, in particular. The reason for this can be considered as follows.

Generally, in the non-aqueous electrolyte secondary battery having the positive active material containing the lithium manganese compound, if the lithium manganese compound is exposed to an electrolyte for a long time, manganese (Mn) is dissolved into the electrolyte from the lithium manganese compound. When the manganese, having been dissolved in the electrolyte, reaches the negative electrode, it may be deposited on the first carbon material, which is a negative active material, to cause the increase in the charge transfer resistance thereof. In addition, the area of the first carbon material intercalating and releasing lithium ion maybe covered with the dissolved manganese, and therefore, the charge and discharge performance of the non-aqueous electrolyte secondary battery may be reduced.

According to this invention, the negative electrode contains the second carbon material having a specific surface area of about 10 to about 1500 m²/g. The second carbon material, which has a large specific surface area, is superior to the first carbon material in the ability of capturing the manganese, so that the manganese having reached the negative electrode is selectively captured on the second carbon material. Therefore, the manganese is hardly deposited on the first carbon material, and the increase in the charge transfer resistance of the first carbon material is suppressed. In addition, since the manganese is hardly deposited on the first carbon material, the area of the first carbon material for intercalating and deintercalating lithium ion can be ensured. Thus, degradation of the negative electrode is prevented, and the cycle life performance, the discharge rate characteristics and the power characteristics are improved.

Particularly, when using a lithium manganese compound represented by a composition of LiₓMn_{2-y}M_{y}O₄ (0≦x≦1.4; 0≦y≦1.8; and M being one or more transition metal elements) or LiₓMn_{1-y}M_{y}O₂ (0≦x≦1.4; 0≦y≦0.9; and M being one or more transition metal elements), the non-aqueous electrolyte secondary battery with improved cycle life performance, discharge rate characteristics and power characteristics can be provided. Here, in the composition of LiₓMn_{2-y}M_{y}O₄ or LiₓMn_{1-y}M_{y}O₂, the transition metal includes Al, Cr, Co, Ni, Mo and W. The lithium manganese compound is more inexpensive than the lithium-cobalt complex oxide which is now widely used and, therefore, can realize a reduced cost of manufacturing the non-aqueous electrolyte secondary battery.

As the binder used in the positive active material layer, although not limited thereto, polyvinylidene fluoride, polytetrafluoroethylene, styrene-butadiene rubber as a rubber polymer, copolymer mainly containing polyvinylidene fluoride, or cellulosic polymer may be used by itself, or a mixture of two or more thereof may be used.

As the separator, although not limited thereto, a known woven fabric, non-woven fabric, synthetic resin porous film or the like may be used. In particular, the synthetic resin porous film is suitably used. Among various synthetic resin porous films, polyolefine porous films including a polyethylene porous film, a polypropylene porous film and a porous film of a composite thereof are suitably used in terms of thickness, film strength, film resistance and the like.

As the non-aqueous electrolyte, any non-aqueous electrolyte or solid electrolyte may be used. As the non-aqueous electrolyte, although not limited thereto, ether, ketone, lactone, nitrile, amine, amido, sulfur compound, halogenated hydrocarbon, ester, carbonate, nitro compound, phosphoric ester compound, phosphazene compound, sulfolane hydrocarbon or the like may be used. Among these, ether, ketone, ester, lactone, halogenated hydrocarbon, carbonate and sulfolane compound are particularly preferred.

Specifically, the non-aqueous electrolyte may be tetrahydrofuran, 2-methyltetrahydrofuran, 1,4-dioxane, anisole, monoglime, 4-methyl-2-pentanone, ethyl acetate, methyl acetate, methyl propionate, ethyl propionate, 1,2-dichloroethane, γ-butyrolactone, dimethoxyethane, methylholmate, dimethylcarbonate, methylethylcarbonate, diethylcarbonate, propylene carbonate, ethylene carbonate, vinylene carbonate, dimethylformamide, dimethyl sulfoxide, dimethylthioformamide, sulfolane, 3-methyl-sulfolane, trimethyl phosphate, triethyl phosphate and a mixture solvent thereof, but it is not limited thereto. Preferably, it is cyclic carbonate or cyclic ester. More preferably, it is an organic solvent of ethylene carbonate, propylene carbonate, methylethylcarbonate or diethylcarbonate or a mixture of two or more of them.

As the electrolyte salt in the non-aqueous electrolyte secondary battery of this invention, although not limited thereto, LiClO₄, LiBF₄, LiAsF₆, CF₃SO₃Li, LiPF₆, LiN(CF₃SO₂)₂, LiN (C₂F₅SO₂)₂, LiI, LiAlCl₄ or LiPF₃(C₂F₅)₃, or a mixture of them may be used. Preferably, LiBF₄, LiPF₆ or LiPF₃(C₂F₅)₃ or a lithium salt obtained by mixing two or more of them is used.

As the solid electrolyte, organic solid electrolyte or inorganic solid electrolyte may be used. As the organic solid electrolyte, a solid and ionic conductive polymer electrolyte may be used, for example. In the case where the polymer electrolyte is constituted by polyethylene oxide, polyacrylonitrile, polyethylene glycol or a modified form thereof, it is lightweight and flexible, and therefore, the rolled electrode can be readily manufactured.

One example of the generating element in the case of using the solid electrolyte is a combination of the positive electrode, the negative electrode, the separator, the organic or inorganic solid electrolyte and the non-aqueous liquid electrolyte. Another example thereof is a combination of the positive electrode, the negative electrode, the organic or inorganic solid electrolyte as the separator and the non-aqueous liquid electrolyte. Here, as the solid electrolyte, a mixture material of the polymer electrolyte and the inorganic solid electrolyte may be used.

The generating element of the non-aqueous electrolyte secondary battery may have various shapes including a rolled type, a folded type and a stacked type. Besides, the non-aqueous electrolyte secondary battery is not limited to a specific shape and may have any shape including a prism shape, a cylinder shape and an elliptic cylinder shape.

Now, examples of this invention will be described. However, this invention should not be limited thereto.

### MANUFACTURE OF BATTERY ACCORDING TO EXAMPLES 1 TO 5

and

### Comparative Example 1

Massive graphite having a specific surface area of 3.2 m²/g was used as the first carbon material, and acetylene black having a specific surface area of 28 m²/g was used as the second carbon material. The negative active materials were obtained by mixing the massive graphite and the acetylene black in the ratios shown in Table 1. A negative compositive was made by mixing 90 parts by weight of the negative active material and 10 parts by weight of polyvinylidene fluoride, and N-methyl-2-pyrrolidone was added to the negative compositive to prepare a slurry. A foamed nickel was filled with the slurry, the slurry was vacuum-dried at 150 degree Celsius to completely volatilize the solvent N-methyl-2-pyrrolidone, and then, the product was pressure-formed. Thus, the negative electrode was obtained.

The pressure-formed negative electrode having an area of 2 cm², a counter electrode made of metallic lithium, and a reference electrode made of metallic lithium were placed in a cell container made of glass. The container was filled with 0.03 dm³ of a non-aqueous electrolyte of 1 mol·dm⁻³ of LiClO₄ in a solvent of ethylene carbonate (EC) and diethylcarbonate (DEC) mixed in the ratio of 50 to 50 by volume. In this way, a battery was manufactured.

(Measurement of Discharge Capacity of Negative Active Material)

The initial service capacity was measured when the battery was charged with a current of 0.5 mA·cm⁻² to a potential of 0.0 V (with respect to the metallic lithium), and then discharged with a current of about 0.5 mA·cm⁻² to a potential of 1.5 V (with respect to the metallic lithium). Here, the calculated service capacity was the service capacity per 1 g of the negative active material containing acetylene black.

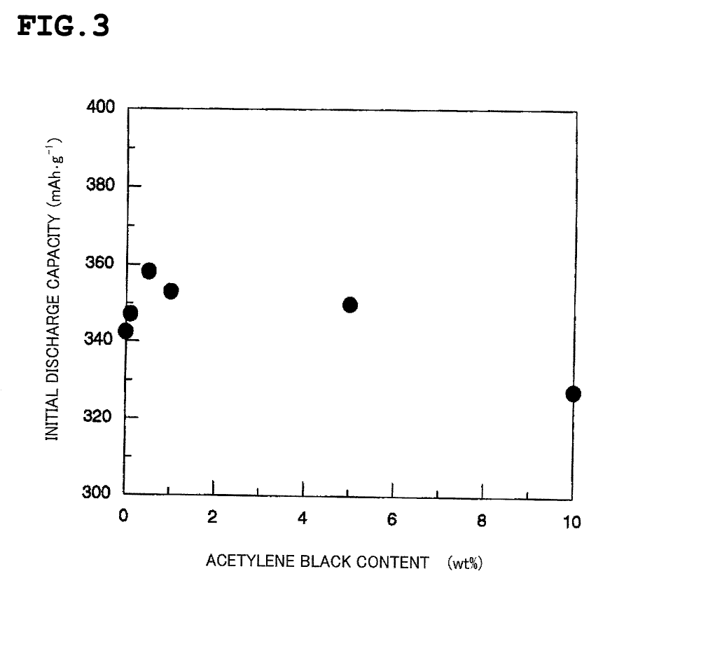

The charge and discharge were repeated under this condition, the discharge capacity per 1 g of the negative active material containing acetylene black after 50 charge and discharge cycles was measured, and then this discharge capacity was divided by the initial discharge capacity to determine the discharge capacity retention. The result is also shown in Table 1. A plot of the relationship between the acetylene black content and the initial discharge capacity is also shown in FIG. 3.

TABLE 1

| | | | Initial | Discharge |
|---|---|---|---|---|
| | Massive | Acetylene | discharge | capacity |
| | graphite | black | capacity | retention |
| | (wt %) | (wt %) | (mAh · g⁻¹) | (%) |
| Comparative | 100 | 0.0 | 342.3 | 96.0 |
| Example 1 | | | | |
| Example 1 | 99.9 | 0.1 | 347.0 | 98.9 |
| Example 2 | 99.5 | 0.5 | 358.2 | 99.8 |
| Example 3 | 99.0 | 1.0 | 353.0 | 99.8 |
| Example 4 | 95.0 | 5.0 | 349.9 | 100 |
| Example 5 | 90.0 | 10.0 | 327.8 | 100 |

From the result of initial discharge capacity shown in Table 1 and FIG. 3, it was proved that the acetylene black content is preferably less than 10% by weight, and more preferably equal to or more than 0.1% by weight and equal to or less than 5% by weight. In addition, from the result of the discharge capacity retention, it was proved that the acetylene black content equal to or less than 10% by weight provides a significant improvement of the service capacity retention.

### MANUFACTURE OF BATTERY ACCORDING TO EXAMPLE 6

and

### Comparative Example 2

For the battery according to Example 6 and Comparative Example 2, massive graphite having a specific surface area of 3.2 m²/g was used as the first carbon material, and acetylene black having a specific surface area of 28 m²/g was used as the second carbon material.

For the battery according to Example 6, 88 parts by weight of the negative active material was obtained by mixing 87.12 parts by weight of the massive graphite and 0.88 parts by weight of the acetylene black. The negative compositive was made by mixing the 88 parts by weight of the negative active material and 12 parts by weight of polyvinylidene fluoride, and N-methyl-2-pyrrolidone was added to the negative compositive to prepare a slurry. In this way, in the battery according to Example 6, the acetylene black content in the sum of the massive graphite and the acetylene black was 1% by weight.

For the battery according to Comparative Example 2, the negative compositive was made by mixing 88 parts by weight of the massive graphite and 12 parts by weight of polyvinylidene fluoride, and N-methyl-2-pyrrolidone was added to the negative compositive to prepare a slurry.

Each of these slurries was spread onto a copper foil having the thickness of 16 μn, vacuum-dried at 150 degrees Celsius to completely volatilize the solvent N-methyl-2-pyrrolidone so that the weight of the spread negative compositive became 1.646 g·100 cm⁻². And then, the product was roller-pressed so as to attain an electrode porosity of 30%.

The negative electrode having an area of 3 cm² thus obtained, a counter electrode made of metallic lithium, and a reference electrode made of metallic lithium were placed in a cell container made of glass. The container was filled with 0.03 dm³ of a non-aqueous electrolyte of 1 mol·dm⁻³ of LiClO₄ in a solvent of ethylene carbonate (EC) and diethylcarbonate (DEC) mixed in the ratio of 50 to 50 by volume. In this way, a battery was manufactured.

(Measurement of Discharge Capacity of Negative Active Material)

The initial discharge capacity was measured when the battery was charged with a current of 0.5 mA·cm⁻² to a potential of 0.0 V (with respect to the metallic lithium), and then discharged with a current of 0.5 mA·cm⁻² to a potential of 1.5 V (with respect to the metallic lithium). Here, the calculated discharge capacity was the discharge capacity per 1 g of the negative active material containing acetylene black.

The charge and discharge were repeated under this condition, the discharge capacity per 1 g of the negative active material containing acetylene black after 50 charge and discharge cycles was measured, and then this service capacity was divided by the initial discharge capacity to determine the discharge capacity retention.

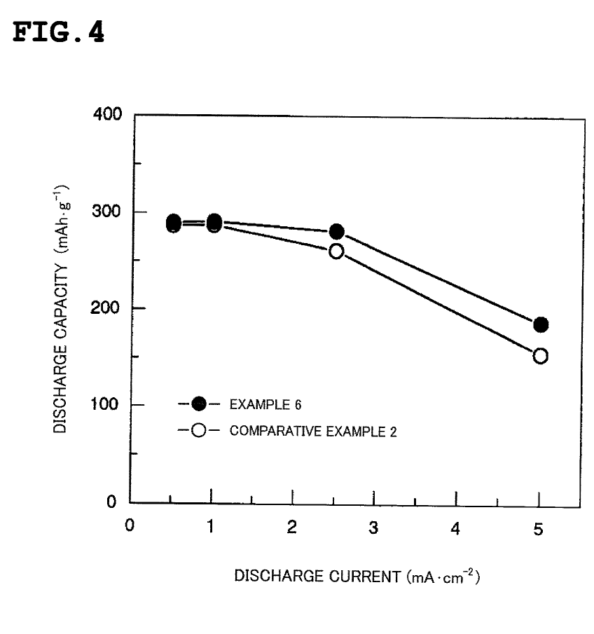

In addition, for evaluation of the load factor characteristics after 50 cycles of charge and discharge, the following measurement was conducted. After 50 cycles of charge and discharge under the above-described condition, the battery was charged with a current of 0.5 mA·cm⁻² to a potential of 0.0 V (with respect to the metallic lithium) and discharged with currents of 0.5 mA·cm⁻², 1.25 mA·cm⁻², 2.5 mA·cm⁻² and 5 mA·cm⁻², respectively, to a potential of 1.5 V (with respect to the metallic lithium). Then, the initial discharge capacity was measured for each of the cases. The results are also shown in Table 2. Besides, for the batteries according to Example 6 and Comparative Example 2, a plot of the relationship between the discharged current after 50 cycles and the discharge capacity is shown in FIG. 4.

TABLE 2

| | | Discharge | Discharge | Discharge | Discharge |
|---|---|---|---|---|---|
| | Discharge | capacity | capacity | capacity | capacity |
| | capacity | for 0.5 | for 1.25 | for 2.5 | for 5 |
| | retention | mA · cm⁻² | mA · cm⁻² | mA · cm⁻² | mA · cm⁻² |
| | (%) | (mAh · g⁻¹) | (mAh · g⁻¹) | (mAh · g⁻¹) | (mAh · g⁻¹) |
| Example 6 | 94.2 | 290.1 | 290.6 | 281.3 | 186.7 |
| Comparative | 92.7 | 287.0 | 287.3 | 261.1 | 154.7 |
| Example 2 | | | | | |

From Table 2 and FIG. 4, it was proved that the battery containing the acetylene black maintains a high discharge capacity retention even after 50 cycles because the increase in the charge transfer resistance thereof is suppressed. In addition, it was proved that it exhibits a high discharge capacity even if the discharge current is increased, which indicates that it has superior load factor characteristics.

### MANUFACTURE OF BATTERY ACCORDING TO EXAMPLES 7 TO 12

and

### Comparative Example 3

Then, the specific surface area of the second carbon material is considered. Massive graphite having a specific surface area of 3.2 m²/g is used as the first carbon material, and acetylene black having a specific surface area of 9 to 133 m²/g is used as the second carbon material.

For the batteries according to Examples 7 to 12, 88 parts by weight of the negative active materials are obtained by mixing 0.88 parts by weight of the acetylene blacks having the respective specific surface areas shown in Table 3 and 87.12 parts by weight of the massive graphite. Then, the negative compositives are prepared by mixing the 88 parts by weight of the respective negative active materials and 12 parts by weight of polyvinylidene fluoride. In this way, in the batteries according to Examples 7 to 12, the acetylene black content in the sum of the massive graphite and the acetylene black is 1% by weight. The batteries are manufactured as in Example 1 except for the negative compositive, and the service capacities of the negative active materials are measured as in Example 1. In addition, as in Example 6, the discharge rate characteristics after 50 cycles of charge and discharge of the batteries are measured.

TABLE 3

| | Specific | Initial | Discharge |
|---|---|---|---|
| | surface area | discharge | capacity |
| | of acetylene | capacity | retention |
| | black (m²g⁻¹) | (mAh · g⁻¹) | (%) |
| Comparative | 9 | 287.2 | 92.6 |
| Example 3 | | | |
| Example 7 | 28 | 288.0 | 93.5 |
| Example 8 | 39 | 288.5 | 93.6 |
| Example 9 | 65 | 290.0 | 93.8 |
| Example 10 | 68 | 290.1 | 94.2 |
| Example 11 | 69 | 289.9 | 94.1 |
| Example 12 | 133 | 289.7 | 93.9 |

TABLE 4

| | Discharge | Discharge | Discharge | Discharge |
|---|---|---|---|---|
| | capacity for | capacity for | capacity for | capacity for |
| | 0.5 mA · cm⁻² | 1.25 mA · cm⁻² | 2.5 mA · cm⁻² | 5 mA · cm⁻² |
| | (mAh · g⁻¹) | (mAh · g⁻¹) | (mAh · g⁻¹) | (mAh · g⁻¹) |
| Comparative | 287.2 | 287.4 | 261.4 | 154.2 |
| Example 3 | | | | |
| Example 7 | 288.1 | 288.4 | 268.8 | 165.0 |
| Example 8 | 288.5 | 288.5 | 275.6 | 178.2 |
| Example 9 | 289.0 | 290.6 | 281.3 | 186.7 |
| Example 10 | 290.3 | 290.7 | 279.8 | 186.6 |
| Example 11 | 289.8 | 289.9 | 280.0 | 186.2 |
| Example 12 | 289.6 | 289.1 | 278.6 | 180.2 |

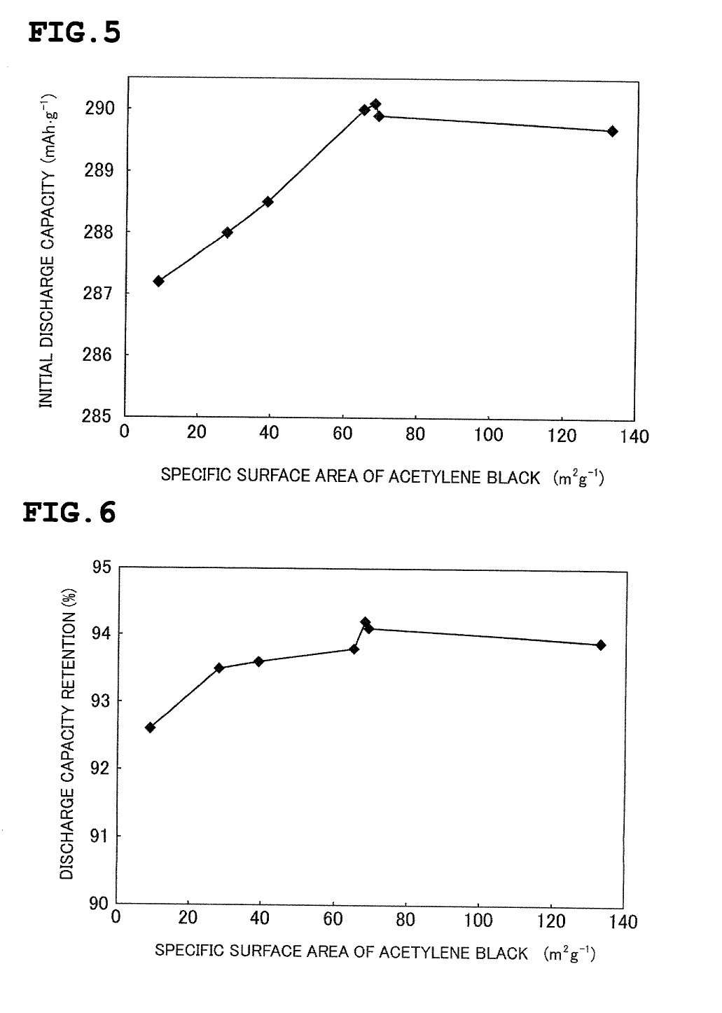

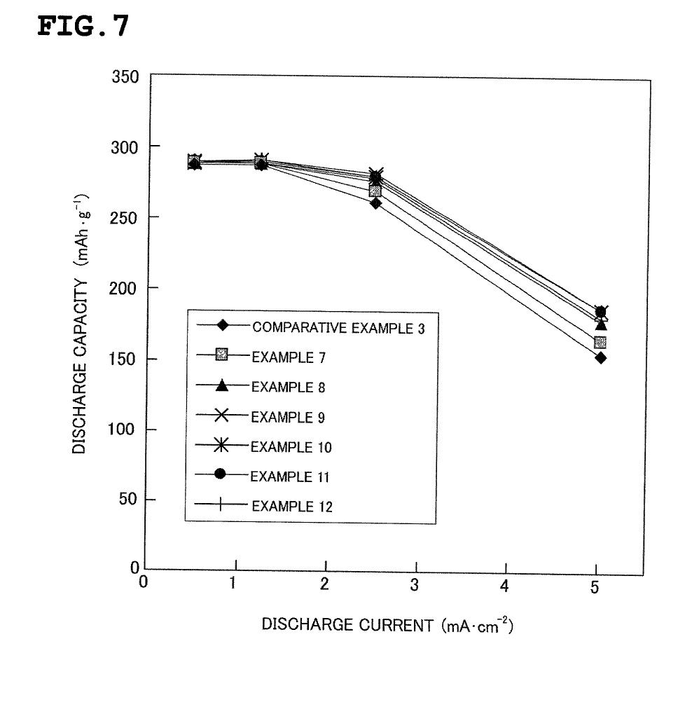

From Tables 3 and 4 and FIGS. 5 to 7, it is proved that the non-aqueous electrolyte secondary battery with superior initial discharge capacity, discharge capacity retention and discharge rate characteristics is provided particularly within the range of the specific surface area of 40 to 80 m²/g.

(Manufacture of Large Battery)

Then, a test was conducted on a large battery. Using the negative electrode manufactured as in Example 6, a battery having a design capacity of about 11.6 Ah according to Example 13 as shown in FIG. 1 was manufactured. In addition, a battery according to Comparative Example 4 was manufactured as in Example 13 except that the negative electrode manufactured as in Comparative Example 2 was used.

In these batteries, the positive electrode was manufactured by mixing 94 parts by weight of LiNi_{0.55}Co_{0.15}Mn_{0.30}O₂ and 6 parts by weight of polyvinylidene fluoride and acetylene black, adding NMP to the product to provide a paste, spreading the paste onto an aluminum foil, and drying the paste to form the positive compositive layer. The band-shaped negative and positive electrodes thus manufactured were wound into an elliptic cylinder with separators sandwiched therebetween to construct a generating element as shown in FIG. 2. After that, the generating element was inserted into a bottom-closed container made of aluminum and having a shape of an elliptic cylinder, the winding center of the generating element was filled with a filler, an electrolyte was injected thereto, and then the container and the lid were welded together with laser-welding.

Here, a non-aqueous electrolyte of 1 mol·dm⁻³ of LiPF₆ in a solvent of ethylene carbonate (EC) and diethylcarbonate (DEC) mixed in the ratio of 50 to 50 by volume was used.

(Output Characteristics Test on Large Battery)

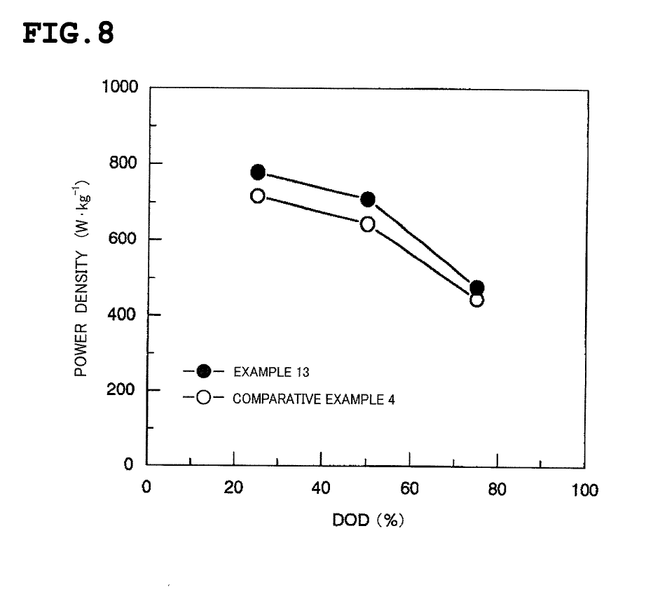

For the large batteries manufactured as described above, the service capacities were measured when the batteries were charged with a constant current of 2A and a constant voltage for 8 hours to a voltage of 4.1 V, and then discharged with a current of 2A to a voltage of 2.7 V. In addition, output densities for the discharge capacities for depths of discharge (DOD) were calculated in conformance with the SAE standard J1798 draft. The result is shown in Table 5. In addition, a plot of the relationship between the respective DODs of the batteries according to Example 13 and Comparative Example 4 and the power density is shown in FIG. 8.

TABLE 5

| | | Power | Power | Power |
|---|---|---|---|---|
| Type of | Discharge | density for | density for | density for |
| negative | capacity | DOD of 25% | DOD of 50% | DOD of 75% |
| electrode | (Ah) | (W · kg⁻¹) | (W · kg⁻¹) | (W · kg⁻¹) |
| Example 13 | 11.6 | 778 | 709 | 477 |
| Comparative | 11.6 | 716 | 643 | 444 |
| Example 4 | | | | |

The battery according to Example 13 exhibited a higher power density for the DODs than the battery according to Comparative Example 4. This test result is considered to be due to the reduced charge transfer resistance of the negative active material.

### MANUFACTURE OF BATTERY ACCORDING TO EXAMPLE 14

and

### Comparative Examples 5 and 6

A case where lithium manganese compound exists was considered in detail. In this consideration, instead of lithium manganese compound used in the positive active material, a non-aqueous electrolyte having Mn (ClO₄)₂ dissolved therein was used. For the battery according to Example 14, massive graphite having a specific surface area of 2.7 m²/g was used as the first carbon material, and acetylene black having a specific surface area of 28 m²/g was used as the second carbon material.

For the battery according to Example 14, 88 parts by weight of the negative active material was obtained by mixing 0.88 parts by weight of the acetylene black and 87. 12 parts by weight of the massive graphite. The negative compositive was made by mixing the 88 parts by weight of the negative active material and 12 parts by weight of polyvinylidene fluoride, and N-methyl-2-pyrrolidone was added to the negative compositive to prepare a slurry. In this way, in the battery according to Example 14, the acetylene black content in the sum of the massive graphite and the acetylene black was 1% by weight.

Each of these slurries was spread onto a copper foil having the thickness of 16 μm, vacuum-dried at 150 degrees Celsius to completely volatilize the solvent N-methyl-2-pyrrolidone so that the weight of the spread negative compositive became 1.646 g·100 cm⁻². And then, the product was roller-pressed so as to attain an electrode porosity of 30%.

The negative electrode having an area of 3 cm² thus obtained, a counter electrode made of metallic lithium, and a reference electrode made of metallic lithium were placed in a cell container made of glass. The container was filled with 0.03 dm³ of a non-aqueous electrolyte of 1 mol·dm⁻³ of LiClO₄ and 5×10⁻⁴ mol·dm⁻³ of Mn(ClO₄)₂ in a solvent of ethylene carbonate (EC) and diethylcarbonate (DEC) mixed in the ratio of 50 to 50 by volume. In this way, the battery according to Example 14 was manufactured.

### Comparative Example 5

The battery according to Comparative Example 5 was manufactured as in Example 14 except that acetylene black having a specific surface area of 9 m²/g was used as the second carbon material.

### Comparative Example 6

The battery according to Comparative Example 6 was manufactured as in Example 14 except that a mixture of 88 parts by weight of massive graphite and 12 parts by weight of polyvinylidene fluoride (PVdF) as the negative compositive.

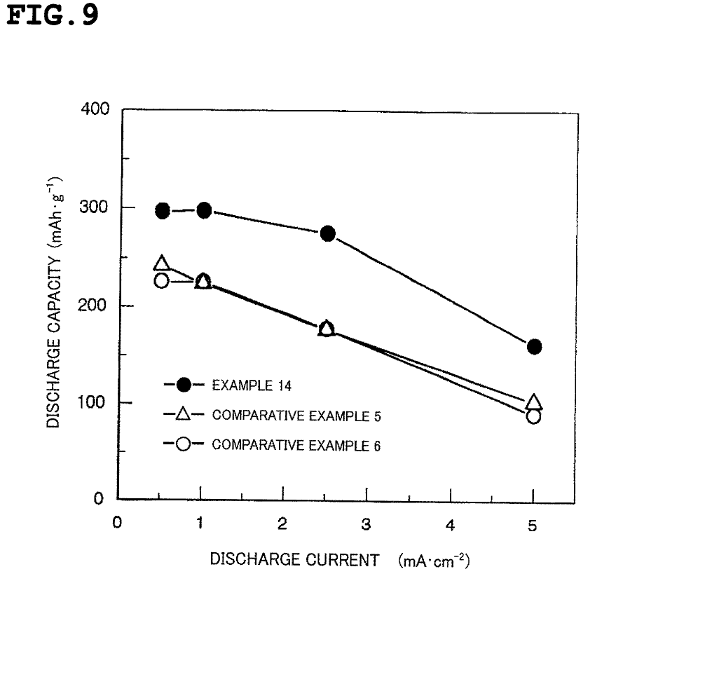

As in Example 1, for the batteries according to Example 14 and Comparative Examples 5 and 6, the discharge capacity of the negative active material was measured, and the discharge capacity retention was calculated. In addition, the discharge rate characteristics after about 50 cycles of charge and discharge was measured as in Example 6. The result is shown in Tables 6 and 7 and FIG. 9.

TABLE 6

| | | | Specific | Discharge |
|---|---|---|---|---|
| | Massive | Acetylene | surface area of | capacity |
| | graphite | black | acetylene black | retention |
| | (wt %) | (wt %) | (m²g⁻¹) | (%) |
| Comparative | 99.0 | 1.0 | 9 | 80.2 |
| Example 5 | | | | |
| Example 14 | 99.0 | 1.0 | 28 | 97.5 |
| Comparative | | | | |
| Example 6 | 100 | 0.0 | — | 77.5 |

TABLE 7

| | Discharge | Discharge | Discharge | Discharge |
|---|---|---|---|---|
| | capacity for | capacity for | capacity for | capacity for |
| | 0.5 mA · cm⁻² | 1.25 mA · cm⁻² | 2.5 mA · cm⁻² | 5 mA · cm⁻² |
| | (mAh · g⁻¹) | (mAh · g⁻¹) | (mAh · g⁻¹) | (mAh · g⁻¹) |
| Comparative | 241.9 | 223.4 | 177.3 | 102.7 |
| Example 5 | | | | |
| Example 14 | 297.9 | 297.1 | 276.1 | 161.7 |
| Comparative | 225.7 | 225.3 | 178.4 | 90.1 |
| Example 6 | | | | |

From Tables 6 and 7 and FIG. 9, it was proved that the battery containing the acetylene black having a specific surface area of 28 m²/g according to Example 14 has a high discharge capacity retention because of the low charge transfer resistance thereof, and it exhibits a high discharge capacity even if the discharge current is increased, which indicates that it has superior discharge rate characteristics. On the other hand, in the cases of the battery not containing acetylene black according to Comparative Example 6 and the battery containing acetylene black having a specific surface area of 9 m²/g according to Comparative Example 5, the capability of selectively capturing manganese is poor, and therefore, the characteristics are inferior to the battery according to Example 14.

(Manufacture of Large Battery)

Then, a test was conducted on a large battery. In Example 15, using the negative electrode manufactured as in Example 14, a battery having a design capacity of 11.6 Ah as shown in FIG. 1 was manufactured. In addition, a battery according to Comparative Example 7 was manufactured as in Example 15 except that the negative electrode manufactured as in Comparative Example 6 was used.

The remainder of these batteries was constructed as in the battery according to Example 13.

(Power Characteristics Test on Large Battery)

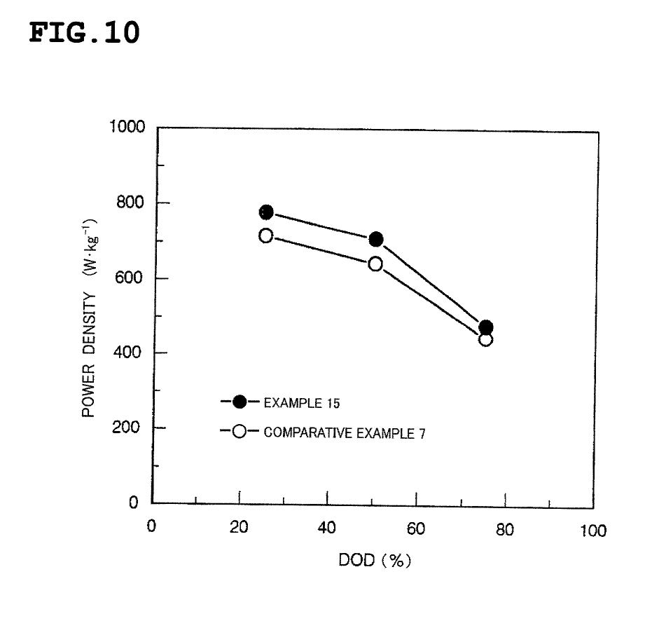

For the batteries according to Example 15 and Comparative Example 7, as in Example 13, the discharge capacities were measured, and the power densities for the depths of discharge (DOD) were calculated. The result is shown in Table 8. In addition, a plot of the relationship between the respective DODs of the batteries according to Example 15 and Comparative Example 7 and the power density is shown in FIG. 10.

TABLE 8

| | | Power | Power | Power |
|---|---|---|---|---|
| | Discharge | density for | density for | density for |
| | capacity | DOD of 25% | DOD of 50% | DOD of 75% |
| | (Ah) | (W · g⁻¹) | (W · g⁻¹) | (W · g⁻¹) |
| Example 15 | 11.6 | 778 | 709 | 477 |
| Comparative | 11.6 | 716 | 643 | 444 |
| Example 7 | | | | |

The battery according to Example 15 exhibited a higher power density for the DODs than the battery according to Comparative Example 7. This test result is considered to be due to the reduced charge transfer resistance of the negative active material.

From the above description, it can be seen that, by providing the negative electrode containing the second carbon material having a specific surface area of 10 to 1500 m²/g, the increase in the charge transfer resistance of the negative electrode is suppressed by the second carbon material, and therefore, the discharge capacity, cycle life performance, discharge rate characteristics and power characteristics of the battery can be improved.

Furthermore, if the positive active material contains lithium manganese compound, the increase in the charge transfer resistance of the first carbon material due to the dissolved manganese can be suppressed, and the area of the first carbon material intercalating and deintercalating lithium ion can be prevented from being covered. Thus, the cycle life performance, discharge rate characteristics and power characteristics of the battery can be improved.

1. A non-aqueous electrolyte secondary battery, comprising:
a positive electrode containing a positive active material capable of intercalating and deintercalating lithium ion; and
a negative electrode containing a first carbon material capable of intercalating and deintercalating lithium ion and a second carbon material having a specific surface area of about 10 to about 1500 m²/g.

2. The non-aqueous electrolyte secondary battery according to claim 1, wherein said second carbon material is carbon black.

3. The non-aqueous electrolyte secondary battery according to claim 2, wherein said carbon black is acetylene black.

4. The non-aqueous electrolyte secondary battery according to claim 3, wherein said first carbon material is selected from a group consisting of non-graphitizing carbon, graphitizing carbon, natural graphite, and artificial graphite.

5. The non-aqueous electrolyte secondary battery according to claim 4, wherein a specific surface area of said first carbon material is about 0.1 to about 10 m²/g.

6. The non-aqueous electrolyte secondary battery according to claim 1, wherein a content of said second carbon material in the sum of said first carbon material and said second carbon material is less than about 10% by weight.

7. The non-aqueous electrolyte secondary battery according to claim 5, wherein a content of said second carbon material in the sum of said first carbon material and said second carbon material is less than about 10% by weight.

8. The non-aqueous electrolyte secondary battery according to claim 1, wherein said positive active material contains lithium manganese compound.

9. The non-aqueous electrolyte secondary battery according to claim 6, wherein said positive active material contains lithium manganese compound.

10. The non-aqueous electrolyte secondary battery according to claim 7, wherein said positive active material contains lithium manganese compound.

11. The non-aqueous electrolyte secondary battery according to claim 8, wherein said lithium manganese compound is represented by a composition of LiₓMn_{2-y}M_{y}O₄ (0≦x≦1.4; 0≦y≦1.8; and M being one or more transition metal elements).

12. The non-aqueous electrolyte secondary battery according to claim 9, wherein said lithium manganese compound is represented by a composition of LiₓMn_{2-y}M_{y}O₄ (0≦x≦1.4; 0≦y≦1.8; and M being one or more transition metal elements).

13. The non-aqueous electrolyte secondary battery according to claim 10, wherein said lithium manganese compound is represented by a composition of LiₓMn_{2-y}M_{y}O₄ (023 x≦1.4; 0≦y≦1.8; and M being one or more transition metal elements).

14. The non-aqueous electrolyte secondary battery according to claim 8, wherein said lithium manganese compound is represented by a composition of LiₓMn_{1-y}M_{y}O₂ (0≦x≦1.4; 0≦y≦0.9; and M being one or more transition metal elements).

15. The non-aqueous electrolyte secondary battery according to claim 9, wherein said lithium manganese compound is represented by a composition of LiₓMn_{1-y}M_{y}O₂ (0≦x≦1.4; 0≦y≦0.9; and M being one or more transition metal elements).

16. The non-aqueous electrolyte secondary battery according to claim 10, wherein said lithium manganese compound is represented by a composition of LiₓMn_{1-y}M_{y}O₂ (0≦x≦1.4; 0≦y≦0.9; and M being one or more transition metal elements).
